(19) United States
(12) Patent Application Publication
(10) Pub. No.: US 2016/0314910 A1
(43) Pub. Date: Oct. 27, 2016

(54) DOMESTIC APPLIANCE WITH AN ELECTROMECHANICAL CONTROL PANEL

(71) Applicant: WHIRLPOOL CORPORATION, Benton Harbor, MI (US)

(72) Inventors: Jakub Buczkowski, Wroclaw (PL); Christina Mazzetti, Cassinetta (IT); Maurizio Peralta, Cassinetta (IT); Luana Spagnoli, Cassinetta (IT)

(73) Assignee: WHIRLPOOL CORPORATION, Benton Harbor, MI (US)

(21) Appl. No.: 15/135,974

(22) Filed: Apr. 22, 2016

(30) Foreign Application Priority Data
Apr. 22, 2015 (EP) 15164673.4

(51) Int. Cl. H01H 3/08

(52) U.S. Cl. CPC H01H 3/08

(57) ABSTRACT

A domestic appliance with a control knob assembly is provided herein. The control knob assembly includes a cylindrical housing coupled to an opening of a panel of the appliance and having at one end an outwardly extending edge configured to abut on the panel. Resilient retainer portions are configured to cooperate with the panel in order to axially mount the housing to the panel. A cylindrical central knob moves axially within the housing between a retracted non-operating position and an extended operating position. An auxiliary retainer portion on an external surface of the housing is configured to cooperate with a portion of the opening of the panel in order to prevent rotation and wobbling of the control knob assembly.

### CROSS-REFERENCE TO RELATED APPLICATION

This application claims priority to European Patent Application No. EP 15164673.4, filed Apr. 22, 2015 and titled “DOMESTIC APPLIANCE WITH AN ELECTROMECHANICAL CONTROL PANEL.”

### BACKGROUND OF THE DISCLOSURE

The present disclosure generally relates to a domestic appliance, and more particularly, to a domestic appliance with an electromechanical control knob with knob assembly assembled to a control panel.

### SUMMARY OF THE DISCLOSURE

According to one aspect of the present disclosure, a domestic appliance with a control knob assembly is provided. The control knob assembly includes a cylindrical housing coupled to an opening of a panel of the appliance and having at one end an outwardly extending edge configured to abut on the panel. Resilient retainer portions are configured to cooperate with the panel in order to axially mount the housing to the panel. A cylindrical central knob moves axially within the housing between a retracted non-operating position and an extended operating position. An auxiliary retainer portion on an external surface of the housing is configured to cooperate with a portion of the opening of the panel in order to prevent rotation and wobbling of the control knob assembly.

According to another aspect of the present disclosure, a control knob assembly of a domestic appliance is provided. The control knob assembly includes a cylindrical housing coupled to an opening of a panel of the appliance and having at one end an outwardly extending edge configured to abut on the panel. Resilient retainer portions are configured to cooperate with the panel in order to axially mount the housing to the panel. A cylindrical central knob moves axially within the housing between a retracted non-operating position and an extended operating position. One or more outwardly extending portions on an external surface of the housing are configured to cooperate with a corresponding number of notches of the opening of the panel in order to prevent rotation and wobbling of the control knob assembly.

According to yet another aspect of the present disclosure, a control knob assembly of a domestic appliance is provided. The control knob assembly includes a cylindrical housing coupled to an opening of a panel of the appliance and having at one end an outwardly extending edge configured to abut on the panel. Resilient retainer portions are configured to cooperate with the panel in order to axially mount the housing to the panel. A cylindrical central knob moves axially within the housing between a retracted non-operating position and an extended operating position. One or more inwardly groove-shaped portions on an external surface of the housing are configured to cooperate with a corresponding number of teeth of the opening of the panel in order to prevent rotation and wobbling of the control knob assembly.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective exploded view of a control knob assembly according to one embodiment;

FIG. 2 is a perspective enlarged view of a component of FIG. 1;

FIG. 3 is a longitudinal cross-section view of the control knob assembly of FIG. 1;

FIG. 4 is an enlarged view of area IV of FIG. 3, according to one embodiment;

FIG. 5 is a another perspective enlarged view of the component of FIG. 2, where an anti-rotation feature is shown;

FIG. 6 is a front view of a portion of a control panel used with the component shown in FIG. 5;

FIG. 7 shows another embodiment of the portion shown in FIG. 6;

FIG. 8 shows another embodiment of the component shown in FIG. 5;

FIG. 9 shows a second embodiment of the control knob assembly shown in FIG. 3;

FIG. 10 is a perspective view of a component used in the assembly shown in FIG. 9;

FIG. 11 is a sectioned perspective view of a third embodiment of the control knob assembly; and

FIG. 12 is similar to FIG. 4 and relates to an installation of the control knob assembly on a glass panel.

### DETAILED DESCRIPTION OF THE PREFERRED EMBODIMENTS

As required, detailed embodiments of the present disclosure are provided herein. However, it is to be understood that the disclosed embodiments are merely exemplary and may be embodied in various and alternative forms. The drawings are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the teachings provided herein.

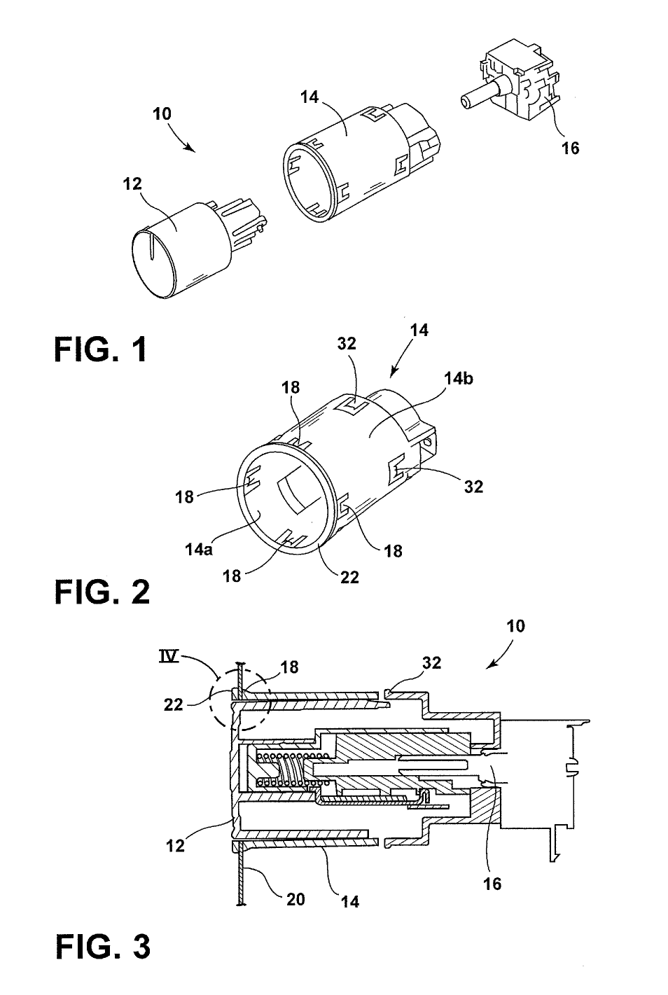

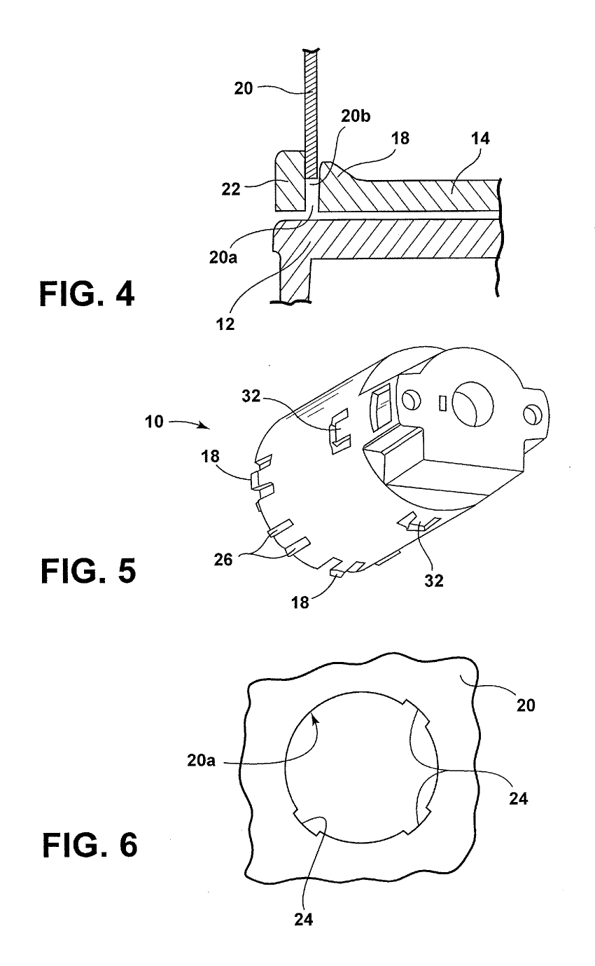

With reference to FIGS. 1-10, a control knob assembly 10 is shown and includes a cylindrical central knob 12, a cylindrical housing 14, and an electronic or electromechanical selector 16. In one embodiment, the knob 12 may be configured as a push-push knob and moves axially within the housing 14 between a retracted non-operating position and an extended operating position. The housing 14 may be made of a plastic material and is provided with a number of resilient retainer portions, which are shown as four snap-fit elements 18 that extend outwardly near an open end 14a of the housing 14 and cooperate with an edge 20b of an opening 20a of a control panel 20 of an appliance when the control knob assembly 10 is axially mounted to the control panel 20. The snap-fit elements 18 may be placed on an external surface 14b of the housing 14 that is not generally visible by a user.

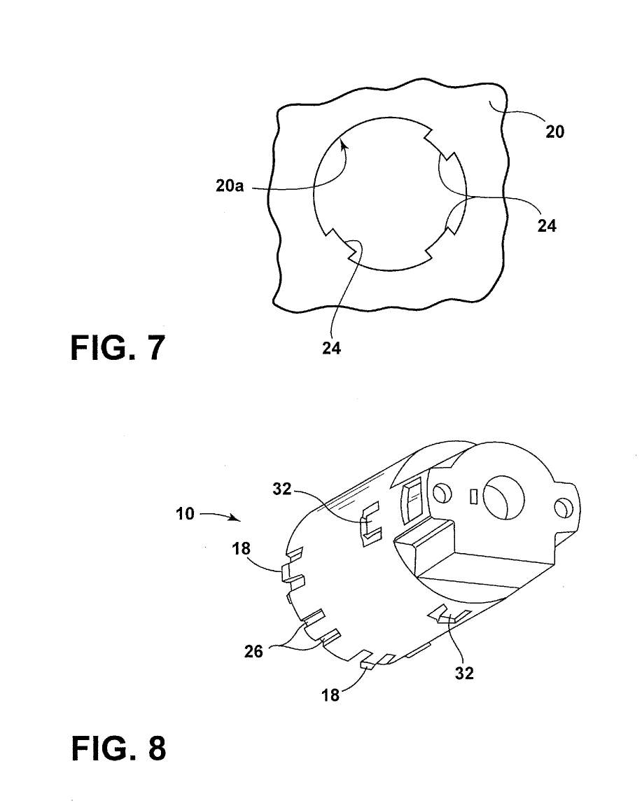

When the housing 14 is inserted in the opening 20a, an outwardly extending edge shown as a disc-shaped bezel 22 of the housing 14 abuts on a front face of the control panel 20 and the snap-fit elements 18 lock the bezel 22 in place and prevent the housing 14 from coming off of the panel 20. The opening 20a of the control panel 20 may include a portion embodied as a number (e.g., three) of notches 24 (FIG. 6). The external surface 14b of the housing 14 may include an auxiliary retainer portion, which may be embodied as a number of outwardly extending portions 26 (FIG. 5) or protrusions that are complimentary to the notches 24. In operation, an anti-wobbling and anti-rotation action is provided by the notches 24 (FIG. 6) of the panel 20 that cooperate with the outwardly extending portions 26 of the housing 14 (FIG. 5) to prevent wobbling and rotation of the housing 14. The shape of the notches 24 may be different from the one shown in the drawings. Moreover the notches 24 may be replaced by corresponding teeth 27 (FIG. 7) inwardly extending on the edge of the opening 20a and configured to cooperate with corresponding longitudinal grooves 28 (FIG. 8) provided on the external surface 14b of the housing 14 in place of the outwardly extending portions 26.

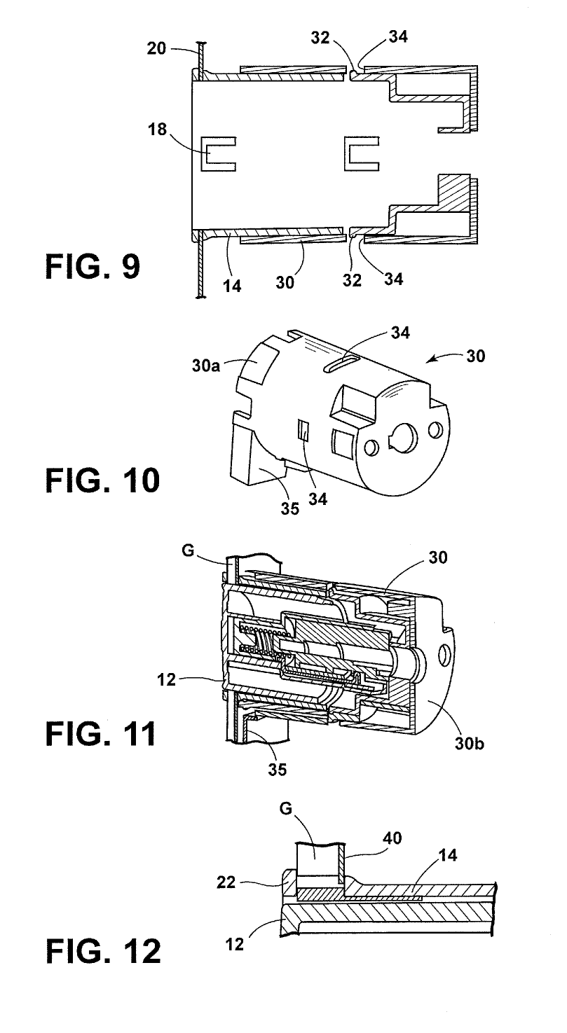

To assure the complete adherence of the aesthetic surface (i.e., the bezel 22 on the control panel 20), a tubular (e.g., pipe-shaped) component 30 (FIGS. 9-11) can be used to eliminate any residual play related to the control knob assembly 10. According to the embodiment shown in FIGS. 9 and 10, the component 30 has an enlarged end 30a, and through a sliding movement, is locked on the housing 14 by one or more outwardly extending snap-fit resilient elements 32 of the housing 14 that cooperate with a corresponding number of openings 34 of the tubular component 30. According to the embodiment shown in FIG. 11, the component 30 has a fastening portion, shown as closed end 30b, which is fastened to the housing 14 by screws (not shown).

The housing 14 may be configured in at least three different variants according to the material thickness of the control panel 20, which affects the snap-fit position. With a metal panel (e.g., FIGS. 3 and 9), the snap-fit elements 18 work directly on the metal surface and the notches 24 and teeth 27 may be directly obtained on the metal panel. With a generic glass panel, which tends to be thicker than a metal panel (for instance 0.7 mm of metal vs. 4 mm of glass), it may not be possible to obtain the teeth 27 directly on the glass surface. So, according to the embodiment shown in FIG. 12, a metal surface 40 could be placed behind the glass G of the control panel 20, to obtain the teeth 27. Alternatively, a support 35 (FIGS. 10 and 11) could provide the anti-rotation instead of the metal surface 40. The use of a plastic panel is similar in terms of thickness to the glass panel, but the notches 24 or teeth 27 can be obtained directly on the panel. In a full-glass aesthetic with a plastic panel, the thickness of the glass is added to the thickness of the plastic. Generally, the plastic thickness of a structural part, like a panel support, is not less than 2.5 mm and the teeth 27 may be obtained on the plastic. Alternatively, an additional support (e.g., support 35) can provide for anti-rotation of the housing 14.

Accordingly, a control knob assembly 10 for use with a domestic appliance has been advantageously provided herein. The control knob assembly 10 eliminates wobbling and may have a reduced cost due to being directly mounted to the panel without any additional support structure(s) such as metal brackets, glue, adhesives, or other components. In addition, by reducing the overall assembly parts, the control knob assembly 10 may be manufactured on the assembly line in a shorter time. Furthermore, the control knob assembly 10 is compatible with a number of panel materials such as metal, glass, or plastic.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A domestic appliance with a control knob assembly comprising:
a cylindrical housing coupled to an opening of a panel of the appliance and having at one end an outwardly extending edge configured to abut on the panel, resilient retainer portions configured to cooperate with the panel in order to axially mount the housing to the panel, a cylindrical central knob moving axially within the housing between a retracted non-operating position and an extended operating position, an auxiliary retainer portion on an external surface of the housing and configured to cooperate with a portion of the opening of the panel in order to prevent rotation and wobbling of the control knob assembly.

2. The domestic appliance of claim 1, wherein the auxiliary retainer portion includes one of a number of outwardly extending portions and a number of inwardly groove-shaped portions.

3. The domestic appliance of claim 1, wherein the portion of the opening includes one of a number of notches and a number of teeth.

4. The domestic appliance of claim 1, further comprising a tubular component provided between the housing and a rear surface of the panel for eliminating residual play of the control knob assembly.

5. The domestic appliance of claim 4, wherein the tubular component includes an enlarged end configured to abut on the rear surface of the panel and a fastening portion configured to be fastened to the housing.

6. The domestic appliance of claim 5, wherein the tubular component includes one or more openings configured to snap engage with a corresponding number of outwardly extending snap-fit resilient elements of the housing.

7. The domestic appliance of claim 5, wherein the fastening portion is a closed end of the tubular component and is fastened to an end of the housing.

8. The domestic appliance of claim 1, wherein the panel includes at least one of a metal, a glass, and a plastic material.

9. A control knob assembly of a domestic appliance, comprising:
a cylindrical housing coupled to an opening of a panel of the appliance and having at one end an outwardly extending edge configured to abut on the panel, resilient retainer portions configured to cooperate with the panel in order to axially mount the housing to the panel, a cylindrical central knob moving axially within the housing between a retracted non-operating position and an extended operating position, one or more outwardly extending portions on an external surface of the housing and configured to cooperate with a corresponding number of notches of the opening of the panel in order to prevent rotation and wobbling of the control knob assembly.

10. The control knob assembly of claim 9, further comprising a tubular component provided between the housing and a rear surface of the panel for eliminating residual play of the control knob assembly.

11. The control knob assembly of claim 10, wherein the tubular component includes an enlarged end configured to abut on the rear surface of the panel and a fastening portion configured to be fastened to the housing.

12. The control knob assembly of claim 11, wherein the tubular component includes one or more openings configured to snap engage with a corresponding number of outwardly extending snap-fit resilient elements of the housing.

13. The control knob assembly of claim 11, wherein the fastening portion is a closed end of the tubular component and is fastened to an end of the housing.

14. The control knob assembly of claim 9, wherein the panel includes at least one of a metal, a glass, and a plastic material.

15. A control knob assembly of a domestic appliance, comprising:
a cylindrical housing coupled to an opening of a panel of the appliance and having at one end an outwardly extending edge configured to abut on the panel, resilient retainer portions configured to cooperate with the panel in order to axially mount the housing to the panel, a cylindrical central knob moving axially within the housing between a retracted non-operating position and an extended operating position, one or more inwardly groove-shaped portions on an external surface of the housing and configured to cooperate with a corresponding number of teeth of the opening of the panel in order to prevent rotation and wobbling of the control knob assembly.

16. The control knob assembly of claim 15, further comprising a tubular component provided between the housing and a rear surface of the panel for eliminating residual play of the control knob assembly.

17. The control knob assembly of claim 16, wherein the tubular component includes an enlarged end configured to abut on the rear surface of the panel and a fastening portion configured to be fastened to the housing.

18. The control knob assembly of claim 17, wherein the tubular component includes one or more openings configured to snap engage with a corresponding number of outwardly extending snap-fit resilient elements of the housing.

19. The control knob assembly of claim 17, wherein the fastening portion is a closed end of the tubular component and is fastened to an end of the housing.

20. The control knob assembly of claim 15, wherein the panel includes at least one of a metal, a glass, and a plastic material.
